(19) United States
(12) Patent Application Publication
(10) Pub. No.: US 2026/0117926 A1
(43) Pub. Date: Apr. 30, 2026

(54) AIRCRAFT DRIVESHAFT WITH ANTI-FLAIL CONTAINMENT SYSTEM

(71) Applicant: Goodrich Corporation, Charlotte, NC (US)

(72) Inventors: Mark R. Gurvich, Middletown, CT (US); Leo J. Veilleux, JR., Wethersfield, CT (US)

(21) Appl. No.: 18/929,216

(22) Filed: Oct. 28, 2024

(51) Int. Cl. F16P 7/00; F16C 3/02

(52) U.S. Cl. CPC F16P 7/00; F16C 3/023; F16C 2326/06; F16C 2326/43

(57) ABSTRACT

A driveshaft system, having a driveshaft having a first shaft end and a second shaft end; a first diaphragm coupling at the first shaft end and a second diaphragm coupling at the second shaft end; and at least one tension member extending within the driveshaft, between the first diaphragm coupling and the second diaphragm coupling.

### BACKGROUND

The embodiments are directed to aircraft engines and more specifically to an aircraft driveshaft with an anti-flail containment system.

A driveshaft in an aircraft engine system is primarily utilized to transmit torsional loads. The driveshaft is configured to be relatively flexible and accommodate potential lateral and axial misalignments during installation and service. Diaphragm couplings may be positioned at opposite ends of a driveshaft to provide the desired lateral and axial flexibility. However, a diaphragm coupling may become damaged in service for various reasons. The driveshaft with the damaged diaphragm coupling should be prevented from experiencing excessive lateral and axial movement during high-speed operations, to avoid additional damage outside of the driveshaft.

### BRIEF SUMMARY

Disclosed is a driveshaft system, the system including a driveshaft having a first shaft end and a second shaft end; a first diaphragm coupling at the first shaft end and a second diaphragm coupling at the second shaft end; and at least one tension member extending within the driveshaft, between the first diaphragm coupling and the second diaphragm coupling.

In addition to one or more aspects of the system or as an alternate the tension member has a first end and a second end; and the first diaphragm coupling has a first end component connected to the first end of the tension member and the second diaphragm coupling has a second end component connected to the second end of the tension member.

In addition to one or more aspects of the system or as an alternate the tension member is a rope.

In addition to one or more aspects of the system or as an alternate the first end of the tension member is connected to the first end component via a first fastener and the second end of the tension member is connected to the second end component via a second fastener.

In addition to one or more aspects of the system or as an alternate, the system includes a plurality of the tension members extending between the first end component and the second end component.

In addition to one or more aspects of the system or as an alternate the tension members are circumferentially distributed within the driveshaft.

In addition to one or more aspects of the system or as an alternate a tension mechanism to control tension in the tension member is disposed within the tension member, between the first and second ends of the tension member.

In addition to one or more aspects of the system or as an alternate the tension mechanism is near one of the first end of the tension member, the second end of the tension member, or an axial middle portion of the tension member.

In addition to one or more aspects of the system or as an alternate, the system includes a plurality of the tension mechanisms axially spaced apart from each other along the tension member.

In addition to one or more aspects of the system or as an alternate the tension mechanism is a turnbuckle.

In addition to one or more aspects of the system or as an alternate the tension member has a first end and a second end; and the first diaphragm coupling has a first end component and a second end component, wherein the first end of the tension member is connected to the first end component and the second end of the tension member extends through the second end component and is secured to a fixed structure; wherein a tension mechanism is disposed along the tension member, between the second end component and the second end of the tension member.

In addition to one or more aspects of the system or as an alternate at least some of the tension mechanisms are turnbuckle.

In addition to one or more aspects of the system or as an alternate the driveshaft includes a first insert connected to an inner surface of the driveshaft near the first diaphragm coupling and a second insert connected to the inner surface of the driveshaft near the second diaphragm coupling, wherein the first and second inserts engage the tension member to limit lateral motion of the driveshaft.

In addition to one or more aspects of the system or as an alternate the first and second inserts are ring-shaped.

Disclosed is another embodiment of the system, including a driveshaft having a first shaft end and a second shaft end; a first diaphragm coupling at the first shaft end and a second diaphragm coupling at the second shaft end; and a telescoping system extending within the driveshaft, between the first diaphragm coupling and the second diaphragm coupling.

In addition to one or more aspects of the another embodiment of the system or as an alternate the telescoping system has a first end and a second end; and the first diaphragm coupling has a first end component connected to the first end of the telescoping system and the second diaphragm coupling has a second end component connected to the second end of the telescoping system.

In addition to one or more aspects of the another embodiment of the system or as an alternate the telescoping system includes a first telescoping member connected to the first end component and a second telescoping member connected to the second end component, wherein the first and second telescoping members overlap along a middle portion of the driveshaft.

In addition to one or more aspects of the another embodiment of the system or as an alternate the telescoping system includes a first telescoping member connected to the first end component and a second telescoping member connected to the second end component and a third telescoping member extending between the first and second telescoping members, wherein the third telescoping member has a first end that overlaps with the first telescoping member and a second end that overlaps with the second telescoping member.

In addition to one or more aspects of the another embodiment of the system or as an alternate the third telescoping member is radially larger than the first and second telescoping members; or the third telescoping member is radially smaller than the first and second telescoping members; or the third telescoping member is radially smaller than the first telescoping member and radially larger than the second telescoping member.

### BRIEF DESCRIPTION OF THE DRAWINGS

The present disclosure is illustrated by way of example and not limited in the accompanying figures in which like reference numerals indicate similar elements.

FIG. 1 shows an axial cross-sectional view of a driveshaft with a tension member that limits lateral and axial movement of the driveshaft upon failure of a coupling, according to an embodiment;

FIG. 2 shows an axial cross-sectional view of a tension mechanism of the tension member, according to an embodiment;

FIG. 3 shows an axial cross-sectional view of the driveshaft of the embodiment of FIG. 1 after failure of a coupling;

FIG. 4 shows an axial cross-sectional view of an embodiment of the driveshaft with the tension member, where the tension mechanism is near one end of the driveshaft;

FIG. 5 shows an axial cross-sectional view of an embodiment of the driveshaft with the tension member, which includes a plurality of tension mechanisms;

FIG. 6 shows an axial cross-sectional view of an embodiment of the driveshaft with the tension member, which includes lateral motion limiting ring structures within the driveshaft, near opposite ends of the driveshaft;

FIG. 7 shows an axial cross-sectional view of the driveshaft of the embodiment of FIG. 6 after failure of a coupling;

FIG. 8 shows an axial cross-sectional view of an embodiment of the driveshaft with a plurality of the tension members;

FIG. 9 shows a diametric cross-sectional view of the driveshaft of FIG. 8 along lines 9-9;

FIG. 10 shows an axial cross-sectional view of an embodiment of the driveshaft with the tension member, where the tension mechanism is axially offset from the driveshaft;

FIG. 11 shows an axial cross-sectional view of a driveshaft with a telescoping system having two telescoping members that limit lateral movement of the driveshaft upon failure of a coupling, according to an embodiment;

FIG. 12 shows an axial cross-sectional view of the driveshaft of FIG. 11 after failure of a coupling;

FIG. 13 shows an axial cross-sectional view of a driveshaft with the telescoping system having three telescoping members that limit lateral movement of the driveshaft upon failure of a coupling, according to an embodiment, and where the first and second (axially outer) telescoping members have a same diameter as each other and the third (axially center) telescoping member has a smaller diameter than the diameter of the first and second telescoping members;

FIG. 13A shows an axial cross-sectional view of an embodiment in which ends of the telescoping members engage with each other to restrict axial motion in opposite directions;

FIG. 14 shows an axial cross-sectional view of the driveshaft of FIG. 13 after failure of a coupling;

FIG. 15 shows an axial cross-sectional view of a driveshaft with the telescoping system having three telescoping members, where the first and second (axially outer) telescoping members have a same diameter as each other and the third (axially center) telescoping member has a larger diameter than the diameter of the first and second telescoping members; and

FIG. 16 shows an axial cross-sectional view of a driveshaft with the telescoping system having three telescoping members, where the first (axially outer) telescoping member has a smaller diameter than the second (axially outer) telescoping member and the third (axially center) telescoping member has a diameter that is between the diameters of the first and second telescoping members.

### DETAILED DESCRIPTION

Aspects of the disclosed embodiments will now be addressed with reference to the figures. Aspects in any one figure are equally applicable to any other figure unless otherwise indicated. Aspects illustrated in the figures are for the purpose of supporting the disclosure and are not in any way intended to limit the scope of the disclosed embodiments. Any sequence of numbering in the figures is for reference purposes only.

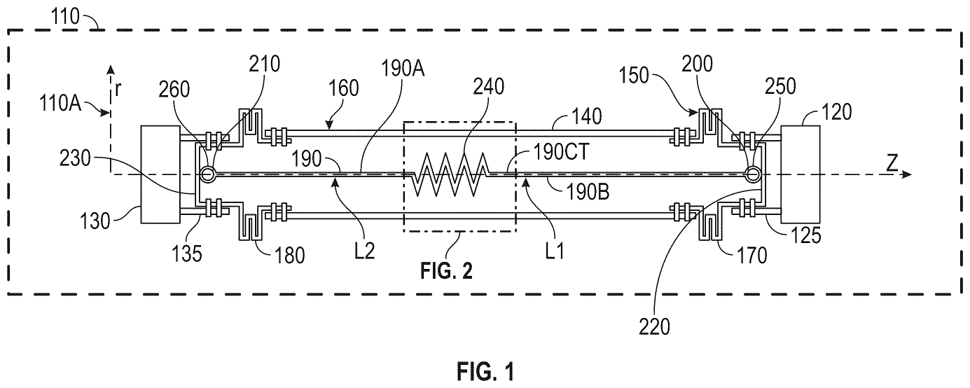

Turning to FIG. 1, a driveshaft system 100A is shown. It should be appreciated that the driveshaft system 100A can be potentially used for a broad range of driveshafts including, for example, rotorcraft, aircraft (i.e., fixed-wing) applications, etc. Specific application identified herein are exemplary only. The driveshaft system 100A as disclosed herein is intended to primarily transfer torque and rotation.

The system 100A may be, for example, part of a gas turbine engine 110. The system 100A may extend between a first engine module (for simplicity a first module) 120 which may be a turbine module and a second engine module (for simplicity a second module) 130 which may be a compressor module. The system 100A may include a driveshaft 140 having a first shaft end 150 at the first module 120 and a second shaft end 160 at the second module 130. A first diaphragm coupling (for simplicity a first coupling) 170 at the first shaft end 150 operationally connects the driveshaft 140 to the first module 120. A second diaphragm coupling (for simplicity a second coupling) 180 at the second shaft end 160 operationally connects the driveshaft 140 to the second module 130. For example, the first module 120 has a first module shaft 125 connected to the first coupling 170 and the second module 130 has a second module shaft 135 connected to the second coupling 180.

A tension member 190 extends within the driveshaft 140, between the first diaphragm coupling 170 and the second diaphragm coupling 180. The tension member 190 has a first end 200 and a second end 210. The first coupling 170 has a first axial end component (for simplicity, illustrated as an end plate) 220 connected to the first end 200 of the tension member 190. The second diaphragm coupling 180 has a second axial end component (for simplicity, also illustrated as an end plate) 230 connected to the second end 210 of the tension member 190.

The first end 200 of the tension member 190 is connected to the first axial end component 220 via a first fastener 250 and the second end 210 of the tension member 190 is connected to the second axial end component 230 via a second fastener 260. The tension member 190 may be a rope. The fasteners 250, 260 may be eyelets.

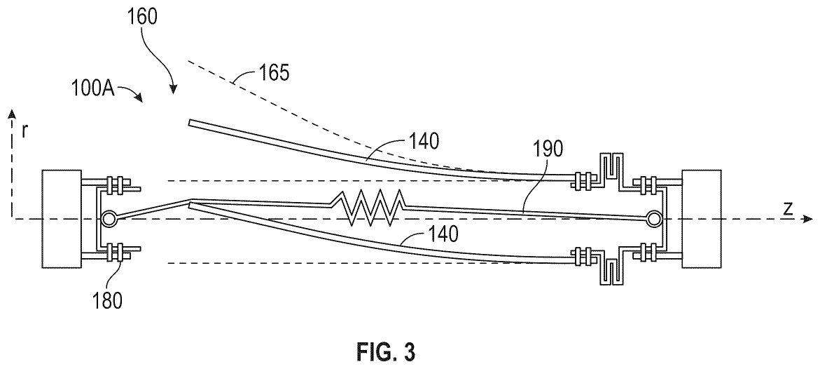

The tension member 190 can include implementations (e.g., the below discussed tension mechanism 240 and/or telescoping system 300, as non-limiting embodiments) providing axial, radial, and angular compliance. There can be different variants of these implementations with respect to locations, designs, materials, etc. For example, in some embodiments, these implementations as additional components can be in a form of metallic springs, combinations of springs or spring-type flexible components. Similarly, in some embodiments, these additional components can be located outside parts 220 (or 230), between parts 220 (or 230) and fasteners 250 (or 260), between fasteners 250 (or 260) and the member 190. With respect to materials, in some embodiments, the additional components providing the compliance can be made of the same material as the tension member or made of different material, including, metals, alloys, fiber-reinforced composites, etc. The same embodiments with respect to the tension member(s) can be applicable to variants described below and illustrated, for example, in FIGS. 3-10.

In some embodiments, the tension member may be made of metal, high strength fibers, such as for example, any combination of carbon, glass and organic fibers, or fiber-reinforced polymer-matrix composite. In some embodiments, the tension member can be formed as a solid body, braided wires or multi stranded braided wires. Iin other embodiments, the tension member can also have a proactive sheath on its exterior which can be metallic or non-metallic, e.g., made of Kevlar fibers.

A tension mechanism 240 is disposed within the tension member 190, between the first and second ends 210, 220 of the tension member 190. The tension mechanism 240 shown in FIG. 1 divides the tension member 190 into first and second segments 190A, 190B. In one embodiment, the tension mechanism 240 is a turnbuckle. In the embodiment of FIG. 1, the tension mechanism 240 is located at a longitudinal middle portion 190CT of the tension member 190. With this configuration, the first and second lengths L1, L2 of the first and second segments 190A, 190B of the tension member 190 are the same as each other.

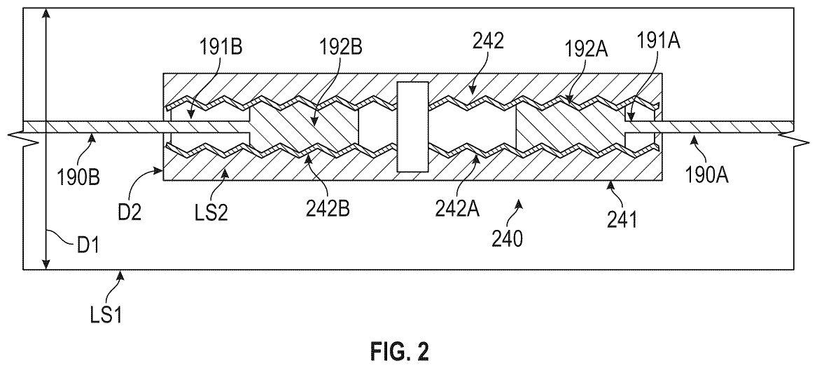

FIG. 2 shows aspects of the tension mechanism 240 according to an embodiment. A connector shaft 241 having a diameter D2 that is smaller than the diameter D1 of the driveshaft 140 and a shaft length LS2 that is shorter than the shaft length LS1 of the driveshaft 140 overlaps first and second inner facing ends 191A, 191B of the segments 190A, 190B of the tension member 190. The connector shaft 241 defines a threaded inner wall 242. The inner facing ends 191A, 191B of the segments 190A, 190B of the tension member 190 has a respective first and second outer threaded lugs 192A, 192B that engage the threads of the connector shaft 241. As with a turnbuckle, rotation of the connector shaft 241 relative to the tension member 190, or vice versa, increases or decreases tension in the tension member 190. The connector shaft 241 optionally may be formed of two axial segments 241A, 241B that may turn relative to each other to independently move the segments 190A, 190B.

FIG. 3 shows the system 100A in a condition when the second coupling 180 has failed. The system 100A prevents the second end 160 of the driveshaft 140 from undergoing axial or lateral displacement beyond limits created by the tension member 190. For example, line 165 shows a potential displacement (flail) that the shaft end 160 of the shaft would experience if the system 100A was not utilized.

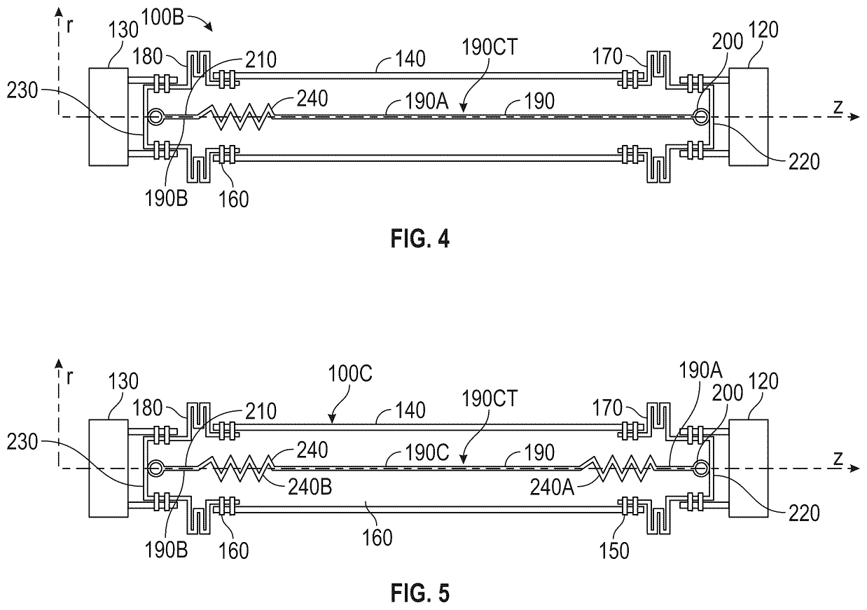

Turning to FIG. 4, an embodiment of the system 100B is shown with the driveshaft 140 extending between and operationally connected to the first and second modules 120, 130 via the first and second couplings 170, 180. The tension member 190 extends between first and second ends 200, 210, which are connected to the first and second end components 220, 230 of the first and second couplings 170, 180. The tension member 190 includes the tension mechanism 240 located between the first and second ends 200, 210 of the tension member 190, dividing the tension member 190 into first and second segments 190A, 190B. The tension mechanism 240 is located closer to one of the first and second modules 120, 130, i.e., offset from a longitudinal middle portion 190CT of the tension member 190. With this configuration, the first and second lengths L1, L2 of the first and second segments 190A, 190B of the tension member 190 differ from each other, i.e., one is longer than the other. As shown in FIG. 4, the tension mechanism 240 is substantially aligned with the second end 160 of the driveshaft 140, though this is not intended on limiting the scope of the embodiments.

Turning to FIG. 5, an embodiment of the system 100C is shown with the driveshaft 140 extending between and operationally connected to the first and second modules 120, 130 via the first and second couplings 170, 180. The tension member 190 extends between first and second ends 200, 210, which are connected to the first and second end components 220, 230 of the first and second couplings 170, 180. The tension member 190 includes a plurality of the tension mechanisms 240, e.g., first and second tension mechanisms 240A, 240B located between the first and second ends 200, 210 of the tension member 190, dividing the tension member 190 into first, second and third segments 190A, 190B, 190C. The first tension mechanism 240A is located closer to the first module 120 than the second tension mechanism 230B. The second tension mechanism 240B is located closer to the second module 130 than the first tension mechanism 240A. The first tension mechanism 240A is substantially aligned with the first end 150 of the driveshaft 140, and the second tension mechanism 240B is substantially aligned with second end 160 of the driveshaft 140, though this is not intended on limiting the scope of the embodiments.

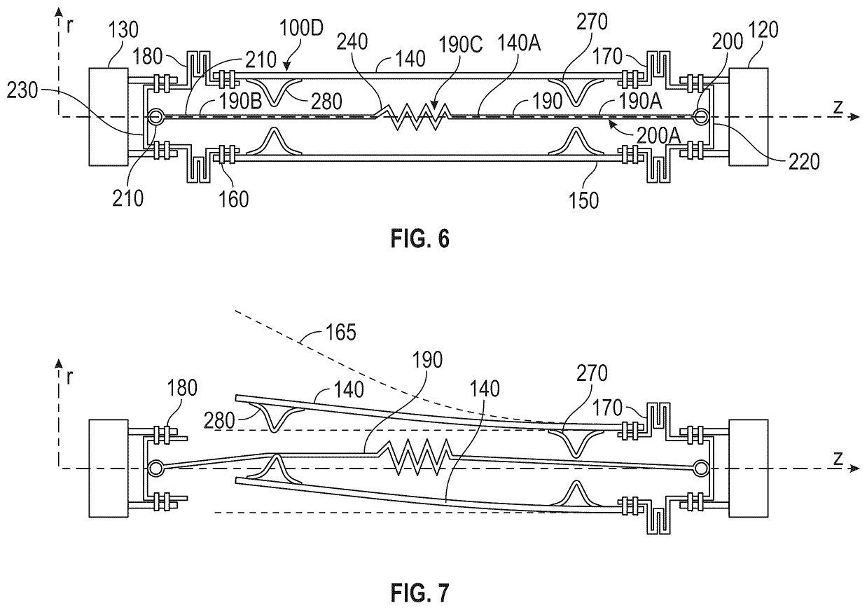

Turning to FIG. 6, an embodiment of the system 100D is shown with the driveshaft 140 extending between and operationally connected to the first and second modules 120, 130 via the first and second couplings 170, 180. The tension member 190 extends between first and second ends 200, 210, which are connected to the first and second end components 220, 230 of the first and second couplings 170, 180. The tension member 190 includes the tension mechanism 240 located between the first and second ends 200, 210 of the tension member 190, dividing the tension member 190 into first and second segments 190A, 190B. The tension mechanism 240 is located at a longitudinal middle portion 190CT of the tension member 190. The shaft includes a first insert 270 connected to an inner surface 140A of the driveshaft 140 near the first diaphragm coupling 170 and a second insert 280 connected to the inner surface 140A of the driveshaft 140 near the second diaphragm coupling 180.

As shown in FIG. 7, the first and second inserts 270, 280 engage the tension member 190 upon failure of respective ones of the first and second couplings 170, 180 to limit lateral motion of the driveshaft 140. The first and second inserts 270, 280 are shown as being ring-shaped structures, though this is not intended on limiting the scope of the embodiments. For example, line 165 shows a potential displacement (flail) that the shaft end 160 of the shaft would experience if the system 100D was not utilized.

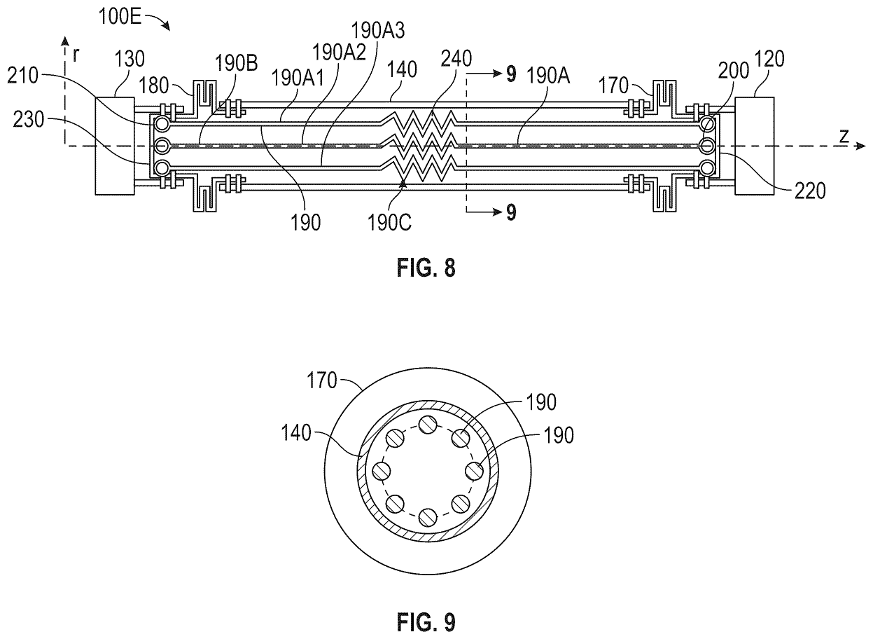

Turning to FIGS. 8 and 9, an embodiment of the system 100E is shown with the driveshaft 140 extending between and operationally connected to the first and second modules 120, 130 via the first and second couplings 170, 180. A plurality of the tension members e.g., 190A1, 190A2, 190A3 (190 for simplicity) each extend between first and second ends 200, 210, which are connected to the first and second end components 220, 230 of the first and second couplings 170, 180. The tension members 190 are circumferentially distributed within the driveshaft 140. Each one of the tension members 190 includes the tension mechanism 240 located between the first and second ends 200, 210 of the tension members 190, dividing each one of the tension members 190 into first and second segments 190A, 190B. Each one of the tension mechanisms 240 is located at a longitudinal middle portion 190CT of respective tension member 190.

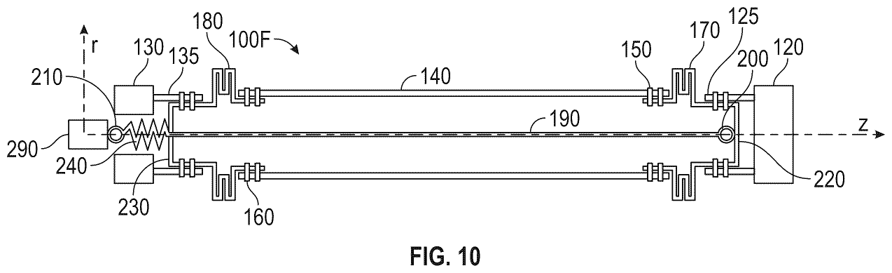

Turning to FIG. 10, an embodiment of the system 100F is shown with the driveshaft 140 extending between and operationally connected to the first and second modules 120, 130 via the first and second couplings 170, 180 having the first and second end components 220, 230. The first end 200 of the tension member 190 is connected to the first axial end component 220. The second end 210 of the tension member 190 extends through the second axial end component 230 and is secured to a fixed structure 290. The tension mechanism 240 is disposed within the tension member 190, between the second axial end component 230 and the second end 210 of the tension member 190. With this configuration, adjustment of the tension mechanism 240 may be more easily accomplished by a mechanic because of ease of access to the tension mechanism 240. That is, in the embodiment of the previous figures, access to the tension mechanism 240 would likely require disconnecting from each other one or more of the module shafts 125, 135, the couplings 170, 180 and the shaft ends 150, 160. The embodiment of FIG. 10 avoids such additional steps to access the tension mechanism 240.

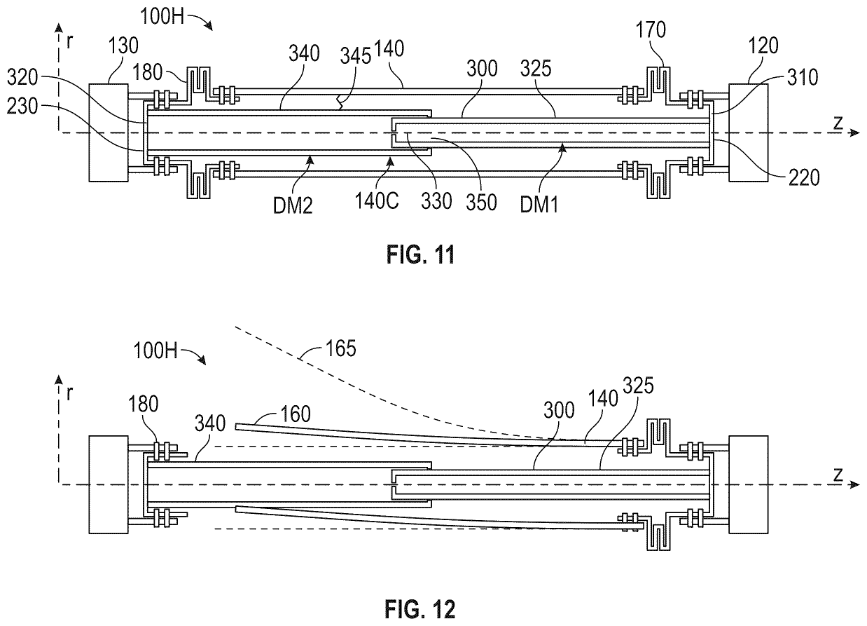

Turning to FIG. 11, an embodiment of the system 100H is shown with the driveshaft 140 extending between and operationally connected to the first and second modules 120, 130 via the first and second couplings 170, 180 having the first and second end components 220, 230. A telescoping system 300 extends within the driveshaft 140, from a first outer end 310 connected to the first diaphragm coupling 170, to a second outer end 320 connected to the second diaphragm coupling 180. The telescoping system 300 has a first telescoping member 325 extending from the first outer end 310 to a first inner end 330. A second telescoping member 340 extends from the second outer end 320 to a second inner end 350. The first and second telescoping members 325, 340 overlap along the middle portion 140C of the driveshaft 140. The first telescoping member 325 has a first member diameter DM1 and the second telescoping member has a second member diameter DM2 which is larger than the first member diameter DM1, though this is not intended on limiting the scope of the embodiments. With this configuration, the first member 325 slides within the second member 340 to obtain the telescoping aspect.

In some embodiments, clearance in the radial direction between the telescopic members can be applied. This clearance can be defined according to expected ranges of deformation to provide a desired level of axial, radial and angular compliance of the entire telescopic system. Springs 345 (FIG. 11) or other methods of compliance may be utilized in the radial clearance to control desired levels of axial, radial and angular compliance. The same embodiments with respect to the clearance can be applied to other variants considered below and illustrated, for example, in FIGS. 11-16.

FIG. 12 shows the system 100H in a condition when the second coupling 180 has failed. The first and second telescoping members 325, 340 of the telescoping system 300 are long enough so that they remain overlapping following a failure of the coupling 180. The system 100H prevents the second end 160 of the driveshaft 140 from undergoing lateral displacement beyond limits created by utilization of the telescoping system 300. For example, line 165 shows a potential displacement (flail) that the shaft end 160 of the shaft would experience if the system 100H was not utilized.

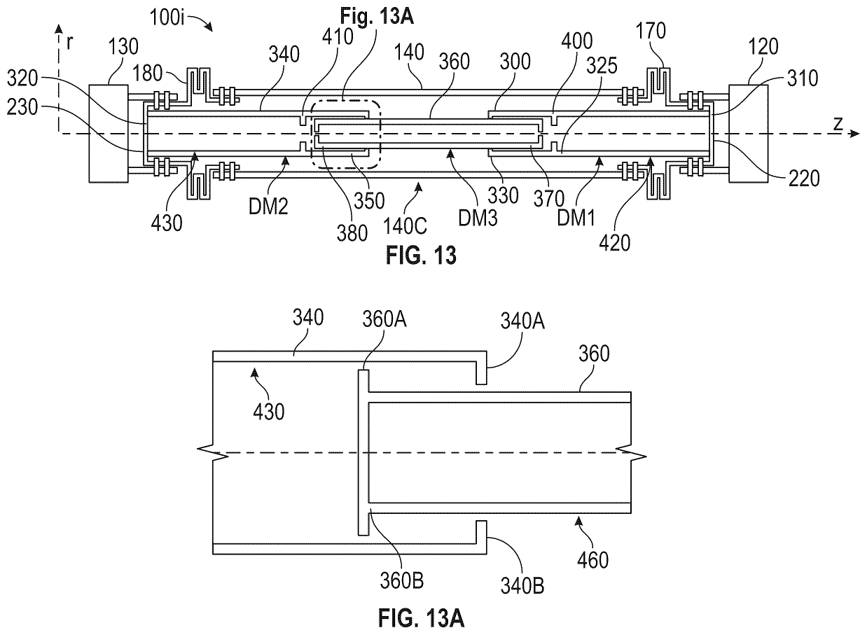

Turning to FIG. 13, an embodiment of the system 100i is shown with the driveshaft 140 extending between and operationally connected to the first and second modules 120, 130 via the first and second couplings 170, 180 having the first and second end components 220, 230. A telescoping system 300 extends within the driveshaft 140, from a first outer end 310 connected to the first diaphragm coupling 170, to a second outer end 320 connected to the second diaphragm coupling 180. The telescoping system 300 has a first telescoping member 325 extending from the first outer end 310 to a first inner end 330. A second telescoping member 340 extends from the second outer end 320 to a second inner end 350. A third telescoping member 360 extends from a first axial end 370 to a second axial end 380. The third telescoping member 360 is oriented so that the first axial end 370 faces the first coupling 170 and the second axial end 380 faces the second coupling 180. The telescoping member 360 is located along the middle portion 140C of the driveshaft 140. The first and third telescoping members 325, 340, 360 are long enough to overlap if one of the couplings 170, 180 fails. The first and second telescoping members 320, 340 have first and second member diameters DM1, DM2 that are the same as each other, and the third telescoping member 360 has a third member diameter DM3 that is smaller than the first and second member diameters DM1, DM2. This way the third telescoping member 360 slides within the first and second telescoping members 325, 340. First and second ring-shaped stops 400, 410 are located along first and second inner walls 420, 430 of the first and second telescoping members 320, 340. This prevents the third telescoping member 360 from sliding beyond a predetermined distance along either of the first and second telescoping members 325, 340.

FIG. 13A shows an alternative connection between telescoping members, e.g. 340, 360, as non-limiting examples. The figure shows a representative embodiment configured to restrict uncontrolled mutual movement of inner and outer tubes 360, 340 with respect to each other. In some embodiments, the inner tube 360 has radially outward part 360A (e.g., an edge, flange, or lip) at its free axial end 360B that faces the inner wall 430 of the outer tube 340. The outer tube 340 has radially inward part 340A (e.g., edge, flange or lip) of its free axial end 340B that faces the outer wall 460 of the inner tube 360. Upon mutual movement of the tubes 340, 360 in axial opposite directions, the parts 340A, 360A restrict axial movement and disengagement upon mutual contact with each other. The parts 340A, 360A can have different geometries and shapes, depending on design objectives and materials. The parts 340A, 360A can be either continuous (e.g., as a ring) or be formed of separate unconnected segments that are circumferentially distributed which can axially mesh with each other. The parts 340A, 360A can be extensions of the same tubes 340, 360 or can be fabricated and installed separately before or during final assembly. In other embodiments, other implementations to resist unconstraint mutual axial movement can also be applied, i.e., the shown implementation not intended to limit the scope of the embodiment.

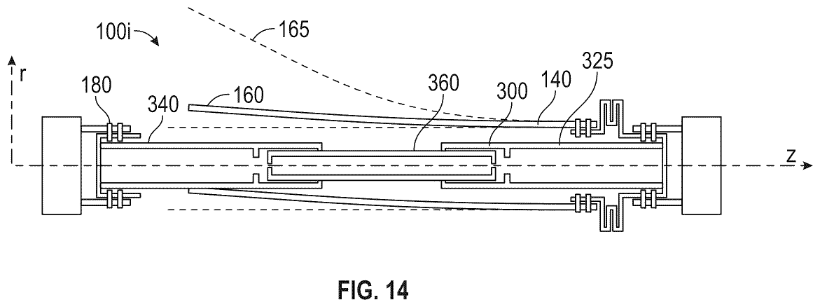

FIG. 14 shows the system 100i in a condition when the second diaphragm coupling 180 has failed. The first, second and third telescoping members 325, 340, 360 are long enough so that they remain overlapping following a failure of the coupling 180. The system 100i prevents the second end 160 of the driveshaft 140 from undergoing lateral displacement beyond limits created by utilization of the telescoping system 300. For example, line 165 shows a potential displacement (flail) that the shaft end 160 of the shaft would experience if the system 100H was not utilized.

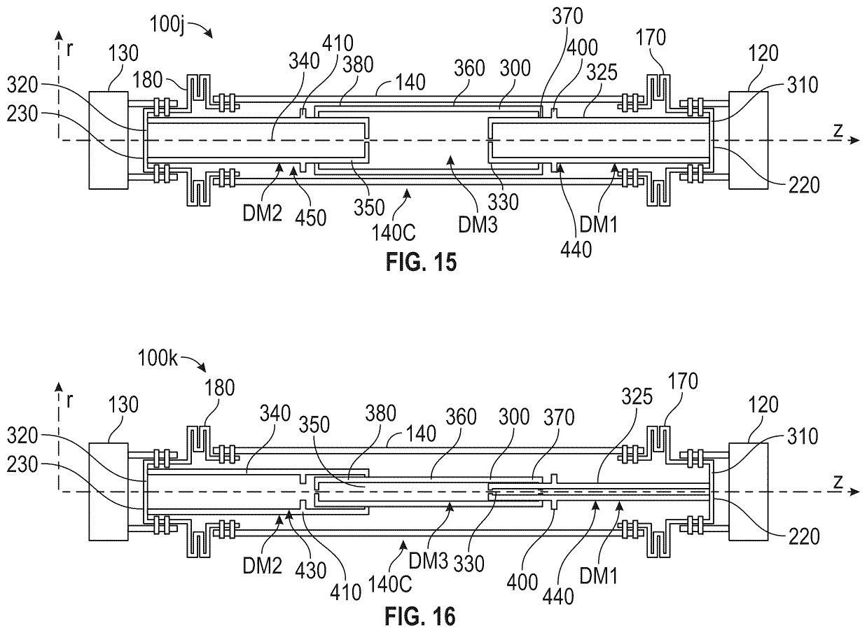

Turning to FIG. 15, an embodiment of the system 100J is shown with the driveshaft 140 extending between and operationally connected to the first and second modules 120, 130 via the first and second couplings 170, 180 having the first and second end components 220, 230. A telescoping system 300 extends within the driveshaft 140, from a first outer end 310 connected to the first diaphragm coupling 170, to a second outer end 320 connected to the second diaphragm coupling 180. The telescoping system 300 has a first telescoping member 325 extending from the first outer end 310 to a first inner end 330. A second telescoping member 340 extends from the second outer end 320 to a second inner end 350. A third telescoping member 360 extends from a first axial end 370 to a second axial end 380. The third telescoping member 360 is oriented so that the first axial end 370 faces the first coupling 170 and the second axial end 380 faces the second coupling 180. The third telescoping member 360 is located along the middle portion 140C of the driveshaft 140. The first and third telescoping members 325, 340, 360 are long enough to overlap if one of the couplings 170, 180 fails. The first and second telescoping members 325, 340 have first and second member diameters DM1, DM2 that are the same as each other, and the third telescoping member 360 has a third member diameter DM3 that is larger than the first and second member diameters DM1, DM2. This way the third telescoping member 360 slides exterior to the first and second telescoping members 320, 340. First and second ring-shaped stops 400, 410 are located along first and second outer walls 440, 450 of the first and second telescoping members 320, 340. This prevents the third telescoping member 360 from sliding beyond a predetermined distance along either of the first and second telescoping members 325, 340.

Turning To FIG. 16, an embodiment of the system 100K is shown with the driveshaft 140 extending between and operationally connected to the first and second modules 120, 130 via the first and second couplings 170, 180 having the first and second end components 220, 230. A telescoping system 300 extends within the driveshaft 140, from a first outer end 310 connected to the first diaphragm coupling 170, to a second outer end 320 connected to the second diaphragm coupling 180. The telescoping system 300 has a first telescoping member 325 extending from the first outer end 310 to a first inner end 330. A second telescoping member 340 extends from the second outer end 320 to a second inner end 350. A third telescoping member 360 extends from a first axial end 370 to a second axial end 380. The third telescoping member 360 is oriented so that the first axial end 370 faces the first coupling 170 and the second axial end 380 faces the second coupling 180. The third telescoping member 360 is located along the middle portion 140C of the driveshaft 140. The first and third telescoping members 325, 340, 360 are long enough to overlap if one of the couplings 170, 180 fails. The first and second telescoping members 320, 340 have first and second member diameters DM1, DM2 such that first member diameter DM1 is smaller than the second member diameter DM2. The third telescoping member 360 has a third member diameter DM3 that is intermediate the first and second member diameters DM1, DM2. With this configuration, the third telescoping member 360 slides exterior to the first telescoping member 325 and interior to the second telescoping member 340. A first ring-shaped stop 400 is located along first outer wall 440 of the first telescoping member 325. A second ring-shaped stop 410 is located along second inner wall 430 of the second telescoping member 320. This prevents the third telescoping member 360 from sliding beyond a predetermined distance along either of the first and second telescoping members 320, 340.

With the above embodiments, the driveshaft with the damaged diaphragm coupling would be prevented from experiencing excessive lateral movement (flail) and axial movement during high-speed operations.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A driveshaft system, comprising:
a driveshaft having a first shaft end and a second shaft end;
a first diaphragm coupling at the first shaft end and a second diaphragm coupling at the second shaft end; and
at least one tension member extending within the driveshaft, between the first diaphragm coupling and the second diaphragm coupling.

2. The system of claim 1, wherein:
the tension member has a first end and a second end; and
the first diaphragm coupling has a first end component connected to the first end of the tension member and the second diaphragm coupling has a second end component connected to the second end of the tension member.

3. The system of claim 2, wherein the tension member is a rope.

4. The system of claim 2, wherein the first end of the tension member is connected to the first end component via a first fastener and the second end of the tension member is connected to the second end component via a second fastener.

5. The system of claim 2, comprising a plurality of the tension members extending between the first end component and the second end component.

6. The system of claim 5, wherein the tension members are circumferentially distributed within the driveshaft.

7. The system of claim 2, wherein a tension mechanism to control tension in the tension member is disposed within the tension member, between the first and second ends of the tension member.

8. The system of claim 7, wherein the tension mechanism is near one of the first end of the tension member, the second end of the tension member, or an axial middle portion of the tension member.

9. The system of claim 7, including a plurality of the tension mechanisms axially spaced apart from each other along the tension member.

10. The system of claim 7, wherein the tension mechanism is a turnbuckle.

11. The system of claim 1, wherein:
the tension member has a first end and a second end; and
the first diaphragm coupling has a first end component and a second end component,
wherein the first end of the tension member is connected to the first end component and the second end of the tension member extends through the second end component and is secured to a fixed structure;
wherein a tension mechanism is disposed along the tension member, between the second end component and the second end of the tension member.

12. The system of claim 9, wherein at least some of the tension mechanisms are turnbuckle.

13. The system of claim 1, wherein the driveshaft includes a first insert connected to an inner surface of the driveshaft near the first diaphragm coupling and a second insert connected to the inner surface of the driveshaft near the second diaphragm coupling, wherein the first and second inserts engage the tension member to limit lateral motion of the driveshaft.

14. The system of claim 13, wherein the first and second inserts are ring-shaped.

15. A driveshaft system, comprising:
a driveshaft having a first shaft end and a second shaft end;
a first diaphragm coupling at the first shaft end and a second diaphragm coupling at the second shaft end; and
a telescoping system extending within the driveshaft, between the first diaphragm coupling and the second diaphragm coupling.

16. The system of claim 15, wherein:
the telescoping system has a first end and a second end; and
the first diaphragm coupling has a first end component connected to the first end of the telescoping system and the second diaphragm coupling has a second end component connected to the second end of the telescoping system.

17. The system of claim 16, wherein
the telescoping system includes a first telescoping member connected to the first end component and a second telescoping member connected to the second end component, wherein the first and second telescoping members overlap along a middle portion of the driveshaft.

18. The system of claim 16, wherein
the telescoping system includes a first telescoping member connected to the first end component and a second telescoping member connected to the second end component and a third telescoping member extending between the first and second telescoping members, wherein the third telescoping member has a first end that overlaps with the first telescoping member and a second end that overlaps with the second telescoping member.

19. The system of claim 18, wherein
the third telescoping member is radially larger than the first and second telescoping members; or
the third telescoping member is radially smaller than the first and second telescoping members; or
the third telescoping member is radially smaller than the first telescoping member and radially larger than the second telescoping member.
